(19) United States
(12) Patent Application Publication
(10) Pub. No.: US 2012/0290282 A1
(43) Pub. Date: Nov. 15, 2012

(54) REACHABILITY ANALYSIS BY LOGICAL CIRCUIT SIMULATION FOR PROVIDING OUTPUT SETS CONTAINING SYMBOLIC VALUES

(75) Inventors: Michael L. Case, Pflugerville, TX (US); Jason R. Baumgartner, Austin, TX (US); Robert L. Kanzelman, Rochester, MN (US); Hari Mony, Austin, TX (US)

(73) Assignee: International Business Machines Corporation, Armonk, NY (US)

(21) Appl. No.: 13/104,478

(22) Filed: May 10, 2011

(51) Int. Cl. G06F 17/50

(52) U.S. Cl. 703/15

(57) ABSTRACT

A logic simulation program, method and system for obtaining a set of reachable states for a logic design that can be used to provide input to other algorithms that simplify the netlist describing the logic design or perform other types of processing, provides an efficient, compact behavior when simulating large designs. Rather than simulating using ternary input and state value representations that are restricted to true, false and unknown, the techniques of the present invention use input symbolic values that are retained in the set of reachable states retained as the output. Behaviors such as oscillators, transient values, identical signals, dependent logical states and chicken-switch determined states can be detected in the simulation results and the netlist simplified using the results of the detection.

### CROSS-REFERENCE TO RELATED APPLICATIONS

The present U.S. patent application is related to co-pending U.S. patent application Ser. No. 13/______, entitled “LOGICAL CIRCUIT NETLIST REDUCTION AND MODEL SIMPLIFICATION USING SIMULATION RESULTS CONTAINING SYMBOLIC VALUES”, filed contemporaneously herewith, the disclosure of which is incorporated herein by reference.

### BACKGROUND OF THE INVENTION

1. Field of the Invention

The present invention is related to circuit simulation by over-approximation techniques that reduce simulation burden over that of exhaustive analysis, and more specifically to simulation programs, methods and systems that use symbolic states in sequential simulations and their results, to enhance the simulation, perform netlist reduction and other model simplification.

2. Description of Related Art

Logic simulators typically verify designs of processor integrated circuits (ICs), as well as other large-scale logic, by observing certain behaviors during the simulation process and reducing the netlist that describes the logic in various ways using the information gathered during the simulation process.

One part of the simulation performed on such devices is reachability analysis, which in present systems is typically an approximate reachability analysis that, through certain assumptions, reduces the amount of time to approximate very closely the state-space that can be reached by the logic in a device, or a portion of a device being simulated. By using values of initial state including both binary states as well as an unknown state, behavior of the logic can be observed and any logic output that appears to resolve to one of the two known states, or to a pattern oscillating between the two known states, can be simplified. Through this process, the simulation can be trimmed dynamically while in process, leading to an approximate, but generally valid description of the state flow of the logic that is obtained in a far shorter time than would be possible with exhaustive simulation.

However, due to the very large and increasing size of logic designs, even existing techniques are time-consuming and memory intensive. Therefore, it would be desirable to provide a simulation program, method and system that have improved performance and/or reduced memory requirements.

### BRIEF SUMMARY OF THE INVENTION

The invention is embodied in a method, computer system and computer program product that perform reachability analysis on a logic design. The computer system is a computer system executing program instructions for carrying out the method and the computer program product is a program for carrying out the method.

The method is a method of simulating a logic design that obtains a set of reachable states containing values of true, false and one or more symbolic values. The resulting output can be used to provide input to other algorithms that simplify the netlist describing the logic design or perform other types of processing. The techniques of the present invention apply symbolic values to the inputs of the logic, at least some of which are retained in the set of reachable states obtained as the output. The method first sets initial values of inputs in the logic design to corresponding symbolic values and simulates sequential operation of the logic design while collecting subsequent states of the logic design in a set of reachable states until a next state of the logic design is a first previous state already present in the set of reachable states. The states in the set of reachable states include values from the symbolic states that were applied to the inputs.

The foregoing and other objectives, features, and advantages of the invention will be apparent from the following, more particular, description of the preferred embodiment of the invention, as illustrated in the accompanying drawings.

### BRIEF DESCRIPTION OF THE SEVERAL VIEWS OF THE DRAWING

The novel features believed characteristic of the invention are set forth in the appended claims. The invention itself, however, as well as a preferred mode of use, further objectives, and advantages thereof, will best be understood by reference to the following detailed description of the invention when read in conjunction with the accompanying Figures, wherein like reference numerals indicate like components, and:

FIG. 1 is a is a flow chart depicting a method in accordance with an embodiment of the present invention.

FIG. 2 is a flow chart depicting a method in accordance with another embodiment of the present invention.

FIGS. 3A-3C are logic flow diagrams showing a sequence of simulation states in a simulation performed in accordance with an embodiment of the present invention.

FIG. 4 is a block diagram illustrating a computer system in which program code according to an embodiment of the present invention implementing a method according to an embodiment of the invention is executed.

### DETAILED DESCRIPTION OF THE INVENTION

The present invention encompasses computer-performed methods and programs for sequentially simulating digital logic circuits for verification and for netlist reduction/simplification. The computer-performed methods implement reachability analyses that explore the states that the logic can assume given a set of values at the inputs to the logic by simulating subsequent state behavior across the set of input value combinations of interest. However, rather than simulating using defined values from the set {TRUE, FALSE} or defined and unknown values from the set {TRUE, FALSE, unknown}, the present invention assigns symbolic values to at least some of the inputs to the logic, permitting the symbolic input values to propagate through the simulation if circuit node states are truly dependent on the symbolic input values, so that the output result of the reachability analysis contain at least some of the symbolic values. The symbolic values can then be used, along with the non-symbolic values in the results, to perform netlist reduction, as well as other logic simplification such as oscillator detection and modeling, transient node detection and chicken switch detection. The above-incorporated U.S. patent application provides detailed disclosure of such netlist reduction and logic simplification, using the output of the methods of the present invention, as well as alternative sources of information that provide analysis results that indicate symbolic relationships within the logic.

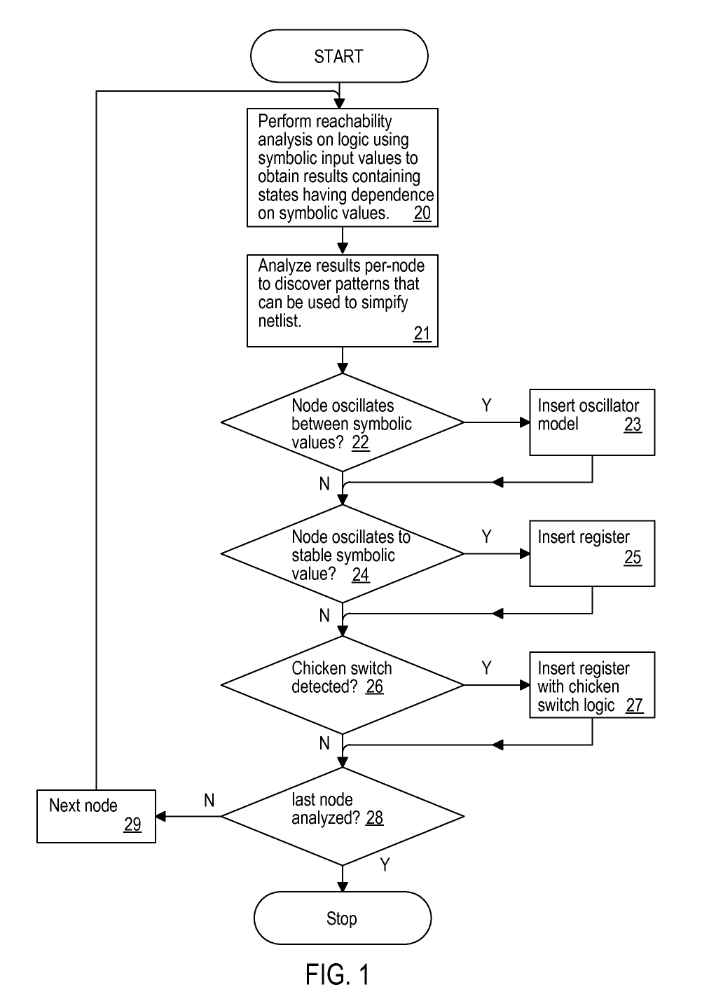

Referring now to FIG. 1, a method for simulating a logic design and modifying the logic design netlist in accordance with an embodiment of the present invention is shown. First, a reachability analysis is performed on the logic model using a set of symbolic input values in order to obtain results containing states having dependence on the symbolic input values (step 20). Next, the results are analyzed to discover patterns that can be used to simplify the netlist, and thus the logic design, providing a simpler logic design that provides the desired behavior, i.e., the behavior being verified or otherwise modeled by the simulation (step 21). The types of netlist reduction that can be performed using the results include:
1) Observations that a node always assumes a constant value for all simulated states. These nodes can be replaced with the constant value rather than the previously-connected logic.
2) Observations that a node has the same value as another node for all simulated states. The nodes can be merged, eliminating redundant or do-nothing logic.

Other types of simplification/netlist reduction are performed according to specific techniques that have been developed for identifying particular circuit behaviors and simplifying the logic netlist to take advantage of the identified behaviors. In the flow chart, if a node is observed to be oscillating between two symbolic values, which includes oscillations between symbolic values or a symbolic value and a constant value (decision 22), then an oscillator model can be inserted in the netlist to replace the logic that was providing the node's state (step 23). Existing phase abstraction techniques can detect oscillators, but not oscillators that are dependent on other logic or the value of an input provided to the logic. Also, if a node quiesces to a stable symbolic value, including stable symbolic values, after an initial portion of circuit operation (decision 24), then a register representing the ultimate stable value can be inserted to represent the node (step 25). If the stable value is a constant, then the register is not needed and the stable value is replaced by the constant value, as in existing temporal decomposition techniques, which cannot detect transient signals that quiesce to stable values other than constants. The present invention also provides for chicken switch detection, which is not possible using the results of ordinary reachability techniques such as ternary simulation. Chicken switches are special configuration bits that are provided to the logic network at power-on. The values of the configuration bits are captured as the initial states of dedicated registers that hold the values of the configuration bits permanently while power is applied to the logic. Chicken switches can be difficult to detect in simulation due to complex logic surrounding the capture-and-hold register. However, using the techniques of the present invention, the dependence of values that are set by chicken switches on initial values of the logical circuit inputs can be detected (decision 26) and a register having the appropriate logic for deriving the chicken switch value inserted in the netlist (step 27). Until the last node of the netlist is analyzed (decision 28), the netlist processing of steps 21-28 is repeated for the next node (step 29). As mentioned above, further details of such processing is disclosed in the above-incorporated U.S. patent application, which can use results of reachability analyses performed with the techniques of the present invention as illustrated in step 20 of FIG. 1.

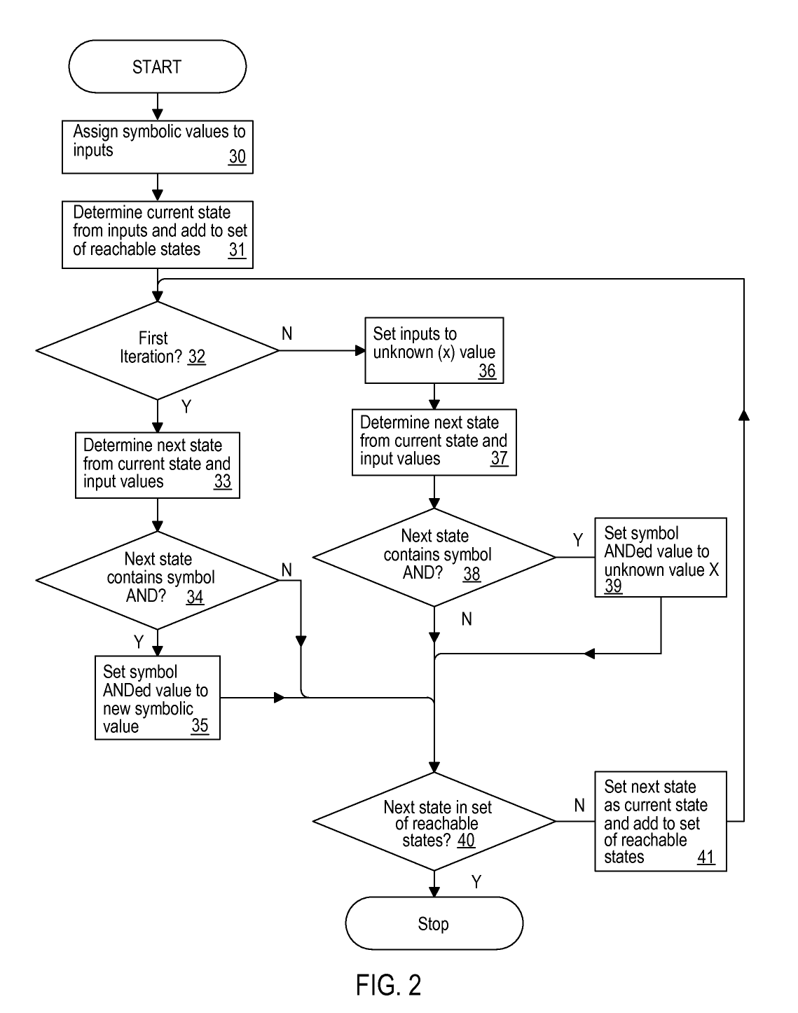

Referring now to FIG. 2, details of a computer-performed method in accordance with another embodiment of the invention are shown that may be used to implement step 20 of FIG. 1. Initially, symbolic values {Xₐ, X_{b}, . . . } are assigned to inputs to the logic (step 30). It is not necessary that every input be specified with a symbolic value, but such modeling is within the scope of the present invention. Depending on additional information available to the simulation designer, certain nodes may be of interest and simulated using symbolic values, while others may be assigned constant values. The current state of the logic nodes are then determined and added to a set of reachable states that is initially empty (step 31). On the first iteration (decision 32), the next state of the logic is determined from the current state and the input values (step 33). If a node has a value in the next state specified as a logical AND of two or more symbolic values (decision 34), then a new symbolic value is introduced to represent the node's value (step 35). On the second iteration and subsequent iterations (decision 32), the input values are set to the unknown value X (step 36) and the next state is determined from the current state and the input values (step 37). If the next state contains a logical AND of two different symbolic values (decision 38), then that value is replaced with the unknown value X (step 39), which helps the routine converge by avoiding continuous introduction of new symbolic values to represent AND-ed (i.e., combined by a logical-AND operation) symbolic values. Until the next state is already in the set of reachable states (decision 40), the next state is set as the current state and is added to the set of reachable states that have been “seen” by the algorithm (step 41). The algorithm illustrated by FIG. 2 is repeated for different portions of the logic design, and also for different possible values of input states that are not being simulated symbolically until all of the desired circuit behavior have been approximated and verified. However, the entire logic design an input space can alternatively be simulated at one time. Each iteration of the algorithm yields a complete set of state patterns for the given initial state, since the final state is one that enters the pattern at an earlier point, just as in typical ternary simulation output, except that the output of the algorithm of FIG. 2 contains states in which nodes have values dependent on or specified directly by the symbolic values. The algorithm illustrated in FIG. 2 can also be exemplified by the following psuedo-code:

```
current_state := the design's initial state
seen := singleton set{current state}
for (time = 0; ; ++time)
{
      if( time == 0)
      {
            foreach input I { I := new_symbol }
            next_state =
            simulate_and_introduce_new_symbols( inputs,
            current_state)
      }
      else
      {
            foreach input I {I := X }
            next_state = simulate( inputs, current_state)
      }
      if ( next_state is contained in seen )
      {
            return seen as the reachability approximation
      }
      else
      {
            seen = seen union next_state
            current_state = next_state
      }
}
```

In order to aid convergence and minimize the number of symbolic unknowns that must be represented by registers in subsequent netlist reduction and other circuit model simplifications, as mentioned above, the introduction of new symbolic values can be restricted to the initial iteration of the simulation algorithm. The above-described behavior is provided by the function simulate_and_introduce_new_symbols( ) that is only applied at time-zero. At all subsequent times, function simulate( ) which does not introduce new symbols. Further, if a new symbolic value has been introduced at any time during the simulation, a table can be maintained that stores the new symbolic value and its “parent” symbolic values that were AND-ed at a node to yield the new symbolic value. Then if the same AND condition is found by the simulation, the previously introduced new symbolic value can be used to label the node's value in the current state at step 39 of FIG. 2, rather than setting the value to unknown value X. Further, relations within the logic design can also be used to avoid introduction of new symbolic values. For example, if a node takes on a value Xₐ & X_{b}, at time==0, requiring introduction of X_{c}=Xₐ & X_{b}, if there is already a relation that shows X_{b}=Xₐ & X_{d} for some X_{d}, then Xₐ & X_{b}=X_{b}, because Xₐ must be TRUE when X_{b} is true due to the above condition. Therefore, introduction of X_{c} can be avoided and the node can be represented by symbolic value X_{b}.

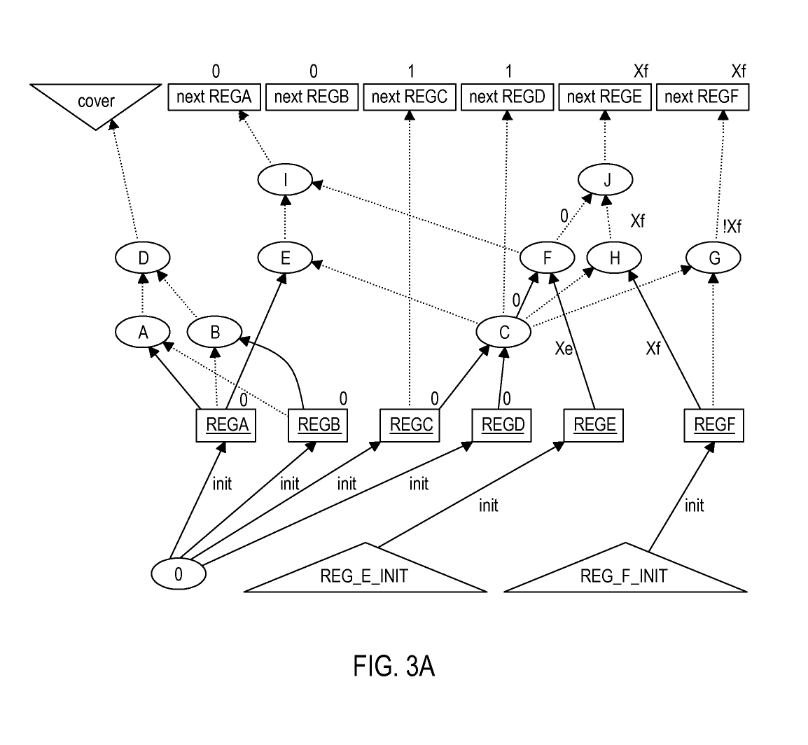

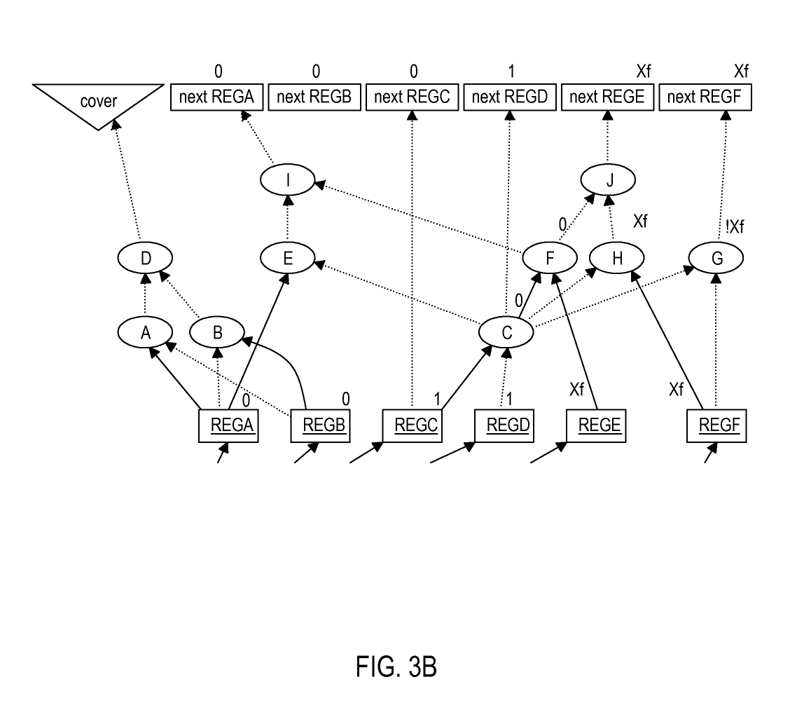

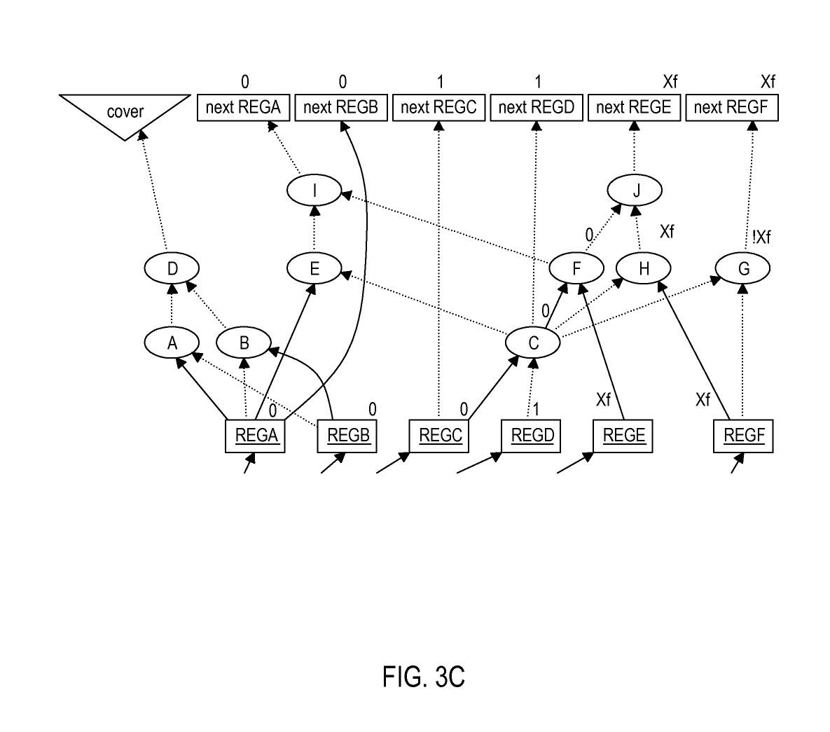

Referring now to FIGS. 3A-3C, a sequence of simulation iterations in a logic design simulated according to the algorithm of FIG. 2 is illustrated. In FIG. 3A, input values of registers REGA, REGB, REGC and REGD are set to constant value 0 (FALSE) during the initial pass through the simulation loop, while input values of registers REGE and REGF are set to corresponding symbolic values Xₑ and X_{f}. The gates generating the outputs of nodes H and G assume values X_{f} and !X_{f}, respectively, while other nodes are all specified by constants. The next state of registers REGA, REGB, REGC, REGD, REGE and REGF is given by the state vector 0011X_{f}X_{f}, as illustrated, indicating that symbolic value Xₑ does not enter the set of “seen” states at all, which will allow later simplification. FIG. 3B, illustrates the next pass through the simulation loop, which illustrates symbolic value Xₑ disappearing from the state flow diagram entirely, and only symbolic value X_{f} remains in the next state of registers REGA, REGB, REGC, REGD, REGE and REGF is given by the state vector 0001X_{f}X_{f}. FIG. 3C illustrates another, final pass of the simulation loop that results in next state of registers REGA, REGB, REGC, REGD, REGE and REGF given by previously seen state vector 0011X_{f}X_{f}, which terminates the current simulation. Further simulation may introduce symbolic values or other constant values for other inputs of the logic design including those shown, and the above sequence is only an example of a portion of an actual simulation, which will typically apply the algorithm depicted in FIG. 2 a large number of times over varying input conditions. Processing of the simulation results depicted in FIGS. 3A-3C can yield the following observations that would not be provided by a typical ternary simulation:
1) X_{f}=REGF (the value of register REGF always)=H=!G=J, which would all be unknowns if X were provided as input to register REGF.
2) REG_E is transient and settles to symbolic value X_{f}
3) register REGF acts as a chicken switch having only an initial value at time==0 that dictates further ramifications in the set of seen states, i.e., subsequent values of the input to register REGF do not appear in the collection of seen states.

Therefore, the logic simulated as shown in FIGS. 3A-3C can be simplified according to the algorithm depicted in FIG. 1, and as further disclose in the above-incorporated U.S. patent application.

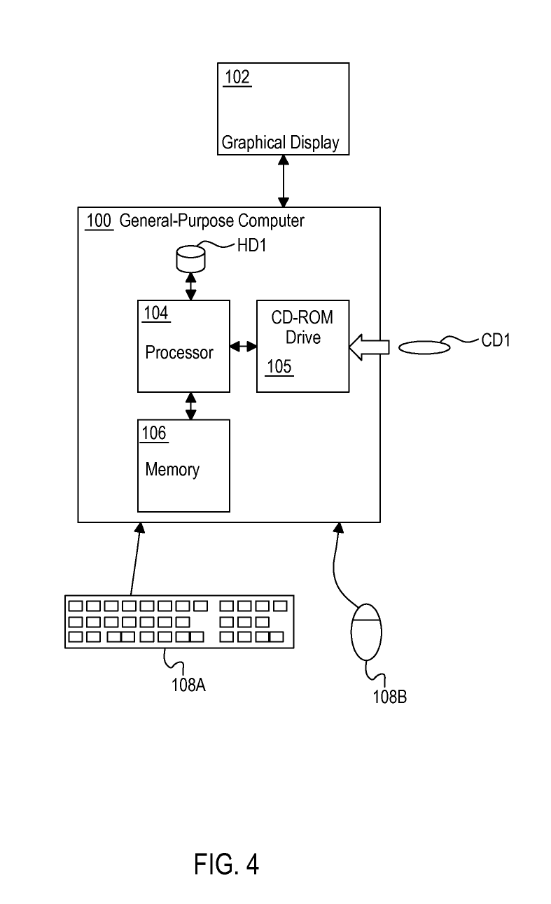

Referring now to FIG. 4, a computer system in which the above-described computer-performed methods are performed, is shown. A general-purpose computer 100 is coupled to a graphical display 102 for display of simulation results, as well as user interface screens for controlling one or more programs including programs forming computer program products including program instructions for carrying out the methods described above. Input devices such as a keyboard 108A and a mouse 108B provide for user interaction with general-purpose computer 100. General-purpose computer 100 includes a processor 104 for executing program instructions stored in a memory 106 including program instructions forming the above-described computer program products in accordance with embodiments of the invention. A removable storage device, such as a DVD-ROM drive 105 is included for accepting storage media such as DVD-ROM DVD1 forming a computer program product in accordance with an embodiment of the invention. The computer system depicted in FIG. 4 is only one example of a computer system such as a desktop computer system or a notebook computer system that can be used to perform the simulations and further processing described above. Other types of computer systems, including distributed and networked computer systems in which some or all of the algorithms and portions thereof are executed remotely are within the scope of the invention as contemplated herein, and the system depicted in FIG. 4 should not be construed as limiting the type of computer system or computer program products that form embodiments of the present invention.

As noted above, portions of the present invention may be embodied in a computer program product, which may include firmware, an image in system memory or another memory/cache, or stored on a fixed or re-writable media such as an optical disc having computer-readable code stored thereon. Any combination of one or more computer readable medium(s) may store a program in accordance with an embodiment of the invention. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

In the context of the present application, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. A computer performed method performed by a general-purpose computer system that simulates a logic design, the method comprising:
first setting initial values of inputs of the logic design to values from among true, false and corresponding symbolic values; and
repeatedly simulating sequential operation of the logic design to obtain a set of reachable states until a next state of the logic design is a first previous state already present in the set of reachable states, wherein the first subsequent states and the set of reachable states include values specified as at least one of the symbolic values.

2. The computer-performed method of claim 1, further comprising second setting the initial values of the inputs of the logic design to an unknown value after evaluation of an initial state of the logic design.

3. The computer-performed method of claim 1, wherein the repeatedly simulating applies a first rule such that a result of a logical AND of two different ones of the symbolic values receives a new symbolic value.

4. The computer-performed method of claim 3, wherein the first rule is applied only during the first iteration of the repeatedly simulating, wherein subsequent iterations of the repeatedly simulating set a result of a logical AND of two different ones of the symbolic values to an unknown value.

5. The computer-performed method of claim 3, wherein the repeatedly simulating applies second rules such that a logical AND of a given one of the symbolic values with the given symbolic value receives a value of the given symbolic value and a logical AND of the given symbolic value with a complement of the given symbolic value receives a value of false.

6. The computer-performed method of claim 3, further comprising determining whether the repeatedly simulating is converging by detecting whether new symbolic values have been introduced during each of a number of immediately previous iterations of the repeatedly simulating, wherein the determining determines that the repeatedly simulating is not converging if the new symbolic values have been introduced during each of the immediately previous iterations of the repeatedly simulating.

7. The computer-performed method of claim 3, further comprising:
storing an indication that the new symbolic value was assigned due to a logical AND of two particular different symbolic values;
determining whether a subsequent application of the first rule is being applied to another logical AND of the same particular symbolic values; and
responsive to determining that the first rule is being applied to the logical AND of the same particular symbolic values, assigning the same new symbolic value to the another logical AND of the same particular symbolic values.

8. A computer system comprising a processor for executing program instructions coupled to a memory for storing the program instructions, wherein the program instructions are program instructions for simulating a logic design, wherein the program instructions comprise program instructions for:
first setting initial values of inputs of the logic design to values from among true, false and corresponding symbolic values; and
repeatedly simulating sequential operation of the logic design to obtain a set of reachable states until a next state of the logic design is a first previous state already present in the set of reachable states, wherein the first subsequent states and the set of reachable states include values specified as at least one of the symbolic values.

9. The computer system of claim 8, wherein the program instructions further comprise program instructions for second setting the initial values of the inputs of the logic design to an unknown value after evaluation of an initial state of the logic design.

10. The computer system of claim 8, wherein the program instructions for repeatedly simulating apply a first rule such that a result of a logical AND of two different ones of the symbolic values receives a new symbolic value.

11. The computer system of claim 10, wherein program instructions for repeatedly simulating only apply the first rule during a first iteration of the repeatedly simulating, wherein subsequent iterations of the repeatedly simulating set a result of a logical AND of two different ones of the symbolic values to an unknown value.

12. The computer system of claim 10, wherein the program instructions for repeatedly simulating apply second rules such that a logical AND of a given one of the symbolic values with the given symbolic value receives a value of the given symbolic value and a logical AND of the given symbolic value with a complement of the given symbolic value receives a value of false.

13. The computer system of claim 9, wherein the program instructions further comprise program instructions for determining whether the repeatedly simulating is converging by detecting whether new symbolic values have been introduced during each of a number of immediately previous iterations of the repeatedly simulating, wherein the program instructions for determining determine that the repeatedly simulating is not converging if the new symbolic values have been introduced during each of the immediately previous iterations of the repeatedly simulating.

14. The computer system of claim 8, wherein the program instructions further comprise program instructions for:
storing an indication that the new symbolic value was assigned due to a logical AND of two particular different symbolic values;
determining whether a subsequent application of the first rule is being applied to another logical AND of the same particular symbolic values; and
responsive to determining that the first rule is being applied to the logical AND of the same particular symbolic values, assigning the same new symbolic value to the another logical AND of the same particular symbolic values.

15. A computer program product comprising a computer-readable storage medium storing program instructions for execution by a general-purpose computer system, wherein the program instructions are program instructions for simulating a logic design, wherein the program instructions comprise program instructions for:
first setting initial values of inputs of the logic design to values from among true, false and corresponding symbolic values; and
repeatedly simulating sequential operation of the logic design to obtain a set of reachable states until a next state of the logic design is a first previous state already present in the set of reachable states, wherein the first subsequent states and the set of reachable states include values specified as at least one of the symbolic values.

16. The computer program product of claim 15, wherein the program instructions further comprise program instructions for second setting the initial values of the inputs of the logic design to an unknown value after evaluation of an initial state of the logic design.

17. The computer program product of claim 15, wherein the program instructions for repeatedly simulating apply a first rule such that a result of a logical AND of two different ones of the symbolic values receives a new symbolic value.

18. The computer program product of claim 17, wherein program instructions for repeatedly simulating only apply the first rule during a first iteration of the repeatedly simulating, wherein subsequent iterations of the repeatedly simulating set a result of a logical AND of two different ones of the symbolic values to an unknown value.

19. The computer program product of claim 17, wherein the program instructions for repeatedly simulating apply second rules such that a logical AND of a given one of the symbolic values with the given symbolic value receives a value of the given symbolic value and a logical AND of the given symbolic value with a complement of the given symbolic value receives a value of false.

20. The computer program product of claim 17, wherein the program instructions further comprise program instructions for determining whether the repeatedly simulating is converging by detecting whether new symbolic values have been introduced during each of a number of immediately previous iterations of the repeatedly simulating, wherein the program instructions for determining determine that the repeatedly simulating is not converging if the new symbolic values have been introduced during each of the immediately previous iterations of the repeatedly simulating.

21. The computer program product of claim 15, wherein the program instructions further comprise program instructions for:
storing an indication that the new symbolic value was assigned due to a logical AND of two particular different symbolic values;
determining whether a subsequent application of the first rule is being applied to another logical AND of the same particular symbolic values; and
responsive to determining that the first rule is being applied to the logical AND of the same particular symbolic values, assigning the same new symbolic value to the another logical AND of the same particular symbolic values.
